(19) United States
(12) Patent Application Publication
(10) Pub. No.: US 2010/0232799 A1
(43) Pub. Date: Sep. 16, 2010

(54) Transmitter for Transmitting Data in an Optical Data Network and Method for Aligning Such a Transmitter

(76) Inventor: Thomas Lueck, Augsburg (DE)

Correspondence Address: SLATER & MATSIL, L.L.P., 17950 PRESTON RD, SUITE 1000, DALLAS, TX, 75252-5793, US

(21) Appl. No.: 12/720,274

(22) Filed: Mar. 9, 2010

(30) Foreign Application Priority Data
Mar. 10, 2009 (DE) 10 2009 012 518.3

(51) Int. Cl. H04B 10/00

(52) U.S. Cl. 398/118

(57) ABSTRACT

A device that can be used in an optical data network includes a receiver and a data port. The receiver receives data transmitted wirelessly by means of modulated light from a transmitter. During operation, the receiver is aligned to the transmitter as a function of a signal strength measured by the receiver. The data port can be connected to a computer system.

This application claims priority to German Patent Application 10 2009 012 518.3, which was filed Mar. 10, 2009 and is incorporated herein by reference.

### TECHNICAL FIELD

The invention relates to a transmitter for transmitting data in an optical data network.

### BACKGROUND

The invention also relates to a method for aligning such a transmitter.

There already exist research approaches for establishing a wireless data network for exchanging information and data between several computers not, as is already common, via radio waves, but via visible light. Here, information is coded by modulated visible light from a light-emitting diode (LED). For example, individual data bits can be transmitted by high-frequency light-dark changes in the light emitted by an LED. Due to the high frequency of the modulation, this is not detectable by the human eye. However, it is possible to receive the modulated signals by means of photodiodes or phototransistors, for example, wherein the transmitted light information can be converted into corresponding electronic signals and processed further.

A transmitter for transmitting information and data in such an optical data network contains at least one photosensitive receiver for receiving signals from another transmitter and optionally at least one LED transmitting diode for sending data by means of modulated light. Finally, the received data can be further processed and decoded and forwarded by means of a data port to a connected computer. Thus it is possible that two or more computers communicate in such an optical data network.

Possible fields of application consist in the interlinking of electronic devices and computer systems by means of the light signals of ceiling lighting in office rooms or in the forwarding of information in the light signals of warning lights, for example, LED tail lights/headlights in automobiles. This state of the art is to be found at http://smartlighting.bu.edu.

Until now, a specified data connection is established between two computers by means of two prototype transmitters whose position in space is known and that are aligned with each other with a mount on a flat surface. These prototype transmitters have the disadvantage, however, that alignment must be performed in a time-intensive and tedious way. Good connection quality is also achievable only with the knowledge of the positions of the transmitters in space.

These transmitters are therefore unsuitable for simple use in an optical data network between mobile devices and LEDs in ceiling lighting as access points for establishing a data connection.

### SUMMARY

In one aspect, the invention discloses a transmitter as well as a method for aligning a transmitter of the type named above, by means of which simpler alignment of a transmitter and an improved connection establishment to another transmitter is guaranteed.

For example, a transmitter is designed such that the one or more receivers can be aligned to the other transmitter as a function of the signal strength measured by the receiver.

This solution of a transmitter has the advantage that the transmitter can be aligned to another transmitter more efficiently, in less time, and optionally without the knowledge of the position of the other transmitter. In this way, an alignment is performed as a function of the signal strength measured by the receiver, so that the transmitter can be best aligned in the direction of the maximum received light signals. Then unidirectional data transmission is possible from the other transmitter to the receiver of the transmitter.

Preferably, the transmitter also has at least one transmitting diode for sending data. In this way, the receiver is aligned together with the transmitting diode to another transmitter, by means of which bidirectional data transmission between the transmitters is possible.

Specifically, the transmitter is designed such that the receiver and optionally the transmitting diode are automatically aligned to the other transmitter. This eliminates manual adjustment of the transmitter and allows an improved and time-saving alignment of the transmitter, even without the knowledge of the position of another transmitter in space.

The transmitter preferably has a display for displaying the signal strength measured by the receiver. By means of the display, however, it is possible for a user also to align the transmitter manually in an efficient way, because the user receives information on the signal strength in space and can align the transmitter in the direction of maximum signal strength.

In a first embodiment, the receiver and optionally the transmitting diode are supported so that they can pivot about a first rotational axis and about a second rotational axis perpendicular to the first rotational axis. Thus the transmitter can be aligned in various spatial directions and can be variably adjusted to the position of another transmitter.

In a second possible embodiment, the transmitter has a flexible gooseneck, on one end of which the data port for connecting to the computer system is arranged and on whose other, distal end the receiver as well as optionally the transmitting diode, are arranged. Here it is conceivable that the transmitter is removable or is arranged fixed onto the computer system, for example, to a monitor. Through this gooseneck setup it is also possible for a user to align the transmitter with the transmitting diode and the receiver optimally in any spatial direction.

In a second aspect, the problem is solved by a method of the type named above in that the transmitter with a receiver and optionally with a transmitting diode automatically aligns to another transmitter if a connection to another transmitter is to be established or maintained. If a user would like to log into the optical data network, for example, with his portable computer, then the transmitter that is connected to the portable computer automatically detects the position of another transmitter that is integrated, for example, in the form of an LED and a phototransistor in the ceiling lighting of an office room, before establishing the connection. It is also conceivable that the transmitter corrects its position relative to the other transmitter if its position has changed, for example, due to the computer being moved. Thus it is guaranteed that an existing data connection is maintained in the best possible way.

Specifically, the receiver of the transmitter measures a signal strength. For example, it is conceivable that another transmitter integrated in the ceiling lighting acts as an access point and outputs continuously modulated light signals into the room due to the turned-on lighting. The receiver of the transmitter that is connected to the portable computer of the user can thus detect signal strength in various room directions.

Specifically, the transmitter initially measures by means of the receiver the signal strength in several specified spatial directions and then takes up that angular position in which the greatest signal strength was measured. Through this grid-like scanning of the room, the transmitter is automatically aligned in the spatial direction from which the best-possible signal quality can be obtained. This can be the direction from which another transmitter transmits directly, but it is also possible that this spatial direction is produced due to reflected light beams.

Specifically, the transmitter detects the change in the signal strength by means of the receiver in a first rotational direction and in a second rotational direction perpendicular to the first rotational direction and corrects its position as a function of the direction of the greatest increase in signal strength. Thus, the transmitter performs a gradient method for the optimal detection of the signal maximum starting from the initially assumed angular position along a scanned spatial direction. This processing step could also be performed during an already existing connection to the other transmitter. In this way it is possible that the transmitter of the portable computer of a user is tracked according to the signal maximum, for example, after movement of the portable computer in the room. Thus, an optimal signal quality between the two transmitters is always guaranteed even in the case of an existing connection in the optical data network.

After the first alignment of the transmitter in a specified spatial direction as a function of the detected signal maximum or as an alternative step, it is also conceivable that the transmitter initially pans about a first rotational axis and then assumes the angular position relative to the first rotational axis in which the greatest signal strength was measured. Furthermore, the transmitter advantageously pans about at least one second rotational axis perpendicular to the first rotational axis and then assumes the angular position relative to the second rotational axis in which the greatest signal strength was measured. In addition to the rough scanning of the room and the aforementioned gradient method, this alternative represents another possibility for the best-possible alignment of a transmitter to another transmitter in the room.

### BRIEF DESCRIPTION OF THE DRAWINGS

Additional implementations are disclosed in the subordinate claims as well as in the description of the figures.

The invention will be explained in greater detail with reference to several figures, which show:

FIG. 1 a part of a computer system with a connected transmitter;

FIG. 2 an arrangement of a part of a computer system with a transmitter and an additional transmitter;

FIG. 3 an arrangement of a part of a computer system with a second construction of a transmitter and an additional transmitter;

FIG. 4a a schematic diagram of an arrangement of two transmitters in a first operating state; and

FIG. 4b a schematic diagram of an arrangement of two transmitters in a second operating state.

The following list of reference symbols can be used in conjunction with the drawings:

1, 2 Transmitter

3 Computer

4 Display

5 Keyboard

6 Data port

7 Display

8 Gooseneck

12, 22 Transmitting diode

13, 23 Receiver

### DETAILED DESCRIPTION OF ILLUSTRATIVE EMBODIMENTS

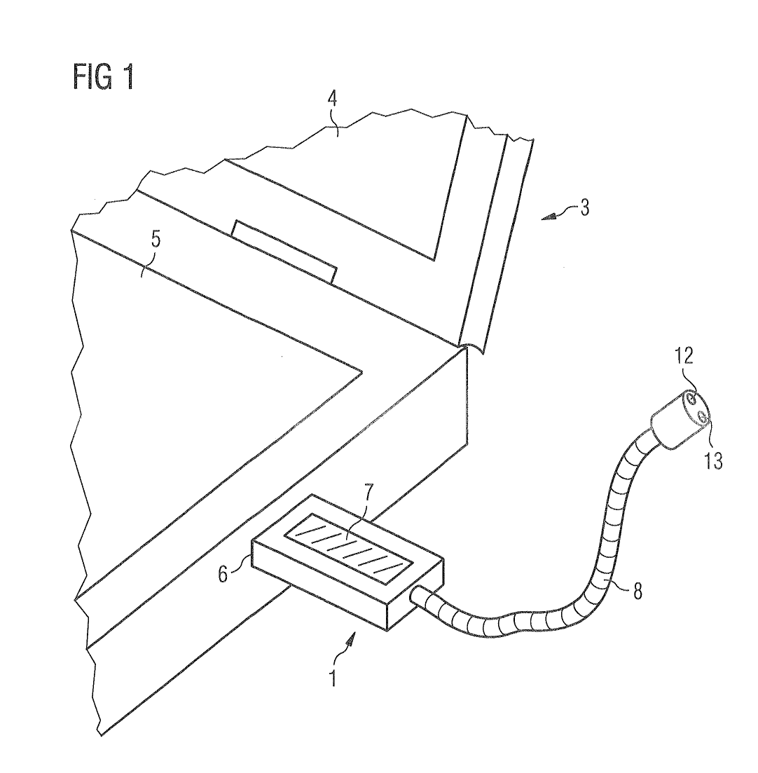

FIG. 1 shows a part of a portable computer system 3 with a display 4 and a keyboard 5. A transmitter 1 for transmitting and receiving data in an optical data network is connected to the computer system 3 by means of a data port 6. In this embodiment, the transmitter 1 has a gooseneck 8, on one end of which the transmitter 1 opens into a base body with a display 7 and the data port 6 for connecting to the computer 3. On the other, distal end, the gooseneck 8 has a transmitting/receiving device with a transmitting diode 12 and a receiver 13. Due to the flexible gooseneck 8, the transmitting/receiving device can be aligned arbitrarily in any spatial direction.

By means of such a transmitter 1, the computer 3 can establish a data connection to another transmitter, wherein the data is transmitted by means of modulated visible light in an optical data network. In this way, the transmitting diode 12 of the transmitter 1 is used for sending out modulated high-frequency light pulses, and the receiver 13 is used for receiving high-frequency light pulses from another transmitter. Transmitted or received data is forwarded to the computer 3 by means of the data port 6. This data port 6 can correspond, for example, to the USB standard (universal serial bus). However, any other type of bus standard, for example, an eSATA port (external serial advanced technology attachment), or LAN port (local area network) is also conceivable for transmitting data to the computer 3.

The receiver 13 of the transmitter 1 includes, for example, a photodiode or a phototransistor for detecting the light signal strength in the surroundings, so that modulated light signals from another transmitter in the room can be detected. The received signals are converted into electronic signals and optionally processed by other signal-processing means, for example, for noise suppression or frequency-dependent amplification of the signal amplitude, wherein the resulting signal strength can be displayed on the display 7 of the transmitter 1. The display 7 can have, for example, several light-emitting diodes for a bar-type representation of the signal quality. A digital display is also conceivable that is used, among other things, for the display of additional information, such as, for example, the transmission power or parameters of the data network.

By means of the display 7, it is possible for a user to monitor the signal strength detected by means of the receiver 13 in the room, while he aligns the transmitter 1 on the gooseneck 8 in the room until the displayed signal strength finally reaches a maximum. This guarantees the best-possible signal quality for establishing an optical data connection to another transmitter in the room. The detected signal maximum need not necessarily be the primary lobe of the light intensity emitted by the other transmitter. It is also possible that one or more secondary lobes of the signal strength will be found that likewise guarantee a high signal quality due to reflections in the room. After aligning the transmitting diode 12 and the receiver 13, the computer 3 can send data in the form of modulated light pulses by means of the light-emitting transmitting diode 12 to another transmitter and can detect light pulses from this transmitter by means of the receiver 13 and can produce and process received data. If the computer 3 changes its position, then the signal change can be monitored on the display 7, and the transmitting diode 12 and also the receiver 13 can be optionally readjusted by means of the gooseneck 8.

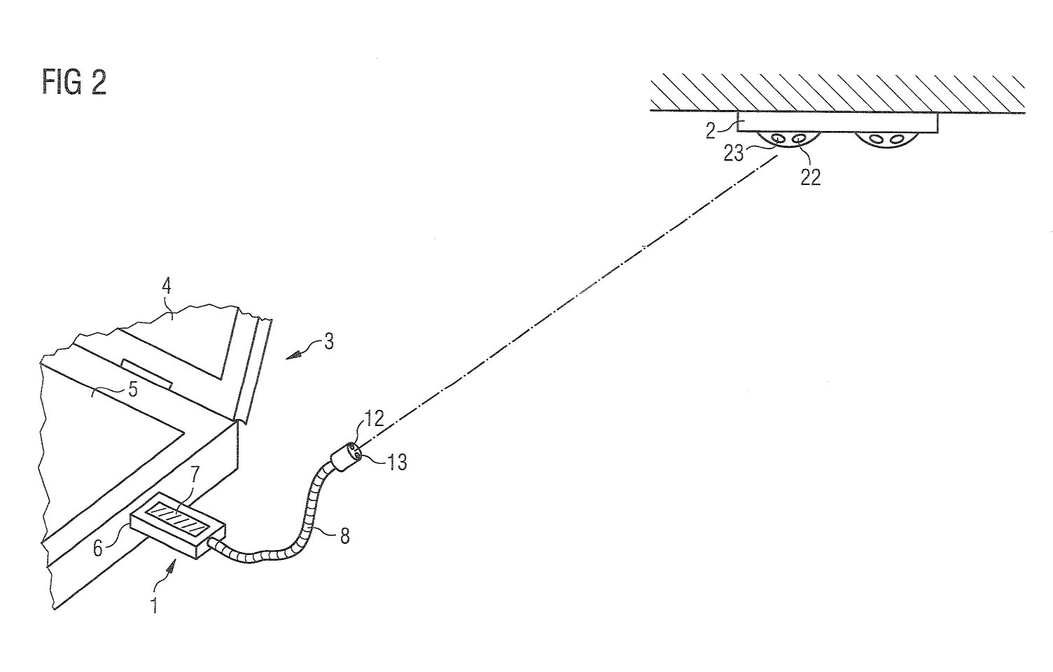

FIG. 2 shows an arrangement of a part of a computer 3 with a transmitter 1 according to FIG. 1 and another transmitter 2 that could be mounted, for example, on a wall or ceiling in a room of an office. The transmitter 1 is aligned with its transmitting diode 12 and its receiver 13 by means of the gooseneck 8 in the viewing direction toward the transmitting diode 22 and the receiver 23 of the other transmitter 2 in the room. The additional transmitter 2 could be integrated, for example, in the ceiling lighting of the room, so that, when the room lighting is turned on, the transmitter 2 continuously sends out light pulses. These light pulses can be received by the receiver 13 of the transmitter 1 on the computer 3 and their intensity could be made visible on the display 7 after signal processing.

After the optimal alignment of the transmitter 1 to a maximum of the emitter light signals from the other transmitter 2, an optical data connection of the computer 3 to the other transmitter 2 is possible by means of the transmitter 1. Here, the computer 3 sends data that is converted into modulated light signals by means of the transmitting diode 12 of the transmitter 1 and that is sent to the receiver 23 of the other transmitter 2. According to the transmission protocol being used, the additional transmitter 2 could itself transmit, parallel in time or offset in time, after reception of the data by means of the receiver 23, additional data in the form of modulated light pulses by means of its transmitting diode 22 to the receiver 13 of the transmitter 1, wherein the received data is conveyed to the computer 3 by means of the data port 6.

In this way, in connection with the display 7, the gooseneck setup 8 of the transmitter 1 guarantees a simple and quick alignment of the transmitting diode 12 and the receiver 13 in the room for establishing a data connection with the best-possible signal quality.

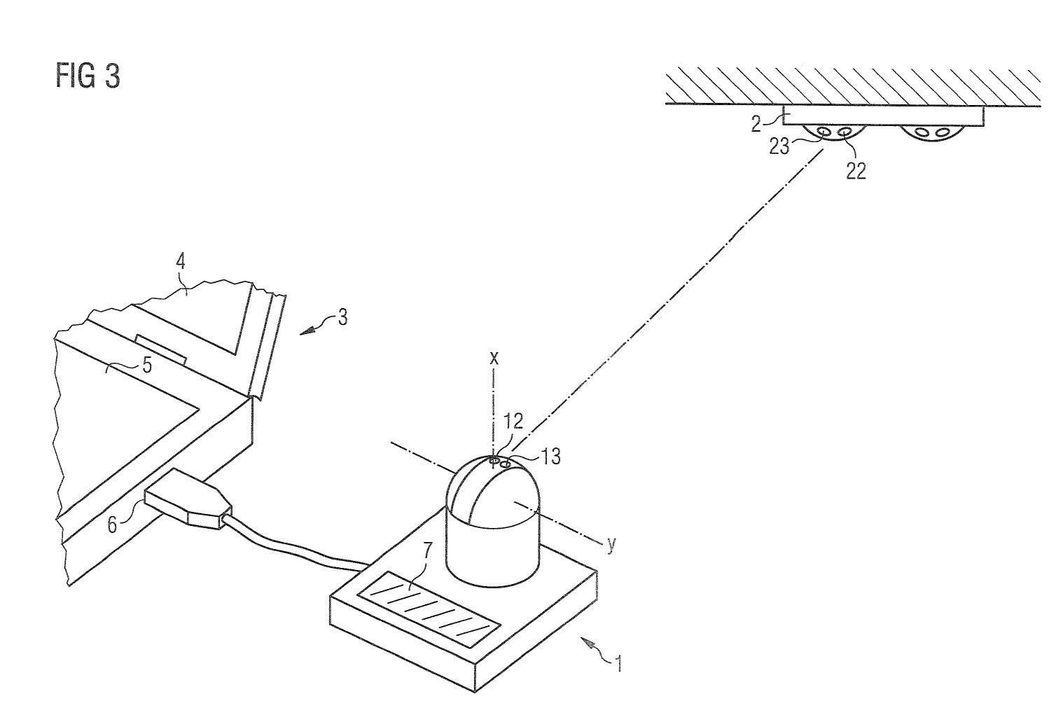

FIG. 3 shows one arrangement of a part of a computer 3 with a transmitter 1 in a second embodiment and another transmitter 2. This embodiment of a transmitter 1 likewise can be connected to a data port 6 of the computer 3 by means of a data cable. In contrast to the embodiments according to FIGS. 1 and 2, the transmitting diode 12 and the receiver 13 of the transmitter 1 in this embodiment are supported so that they can pivot about two rotational axes X and Y. At the same time, the transmitter 1 also has a display 7 for displaying the signal quality and additional connection parameters. For aligning the transmitter 1 to the other transmitter 2, a user could now pivot the transmitting diode 12 and the receiver 13 relative to the X axis and the Y axis, wherein the signal strength received by means of the receiver 13 is displayed by means of the display 7. For example, the user could manually align the transmitting diode 12 and the receiver 13 so that a maximum of the received signal strength in the room is detected and the transmitter 1 is therefore aligned in the best possible way for establishing a data connection to the other transmitter 2.

In the case of the embodiment shown in FIG. 3, it is also conceivable that the transmitter 1 with the transmitting diode 12 and its receiver 13 automatically aligns to the other transmitter 2. Here, various methods for detecting the best possible signal strength can be used. It is conceivable, for example, that the transmitter 1 initially measures the signal strength in several specified spatial directions and then aligns itself to the angular position in which the maximum signal strength was detected. In parallel to or after this processing step, a gradient method, for example, could be used, wherein the position of the transmitting diode 12 and the receiver 13 is changed by a differential piece relative to the rotational axes X and Y and the position is then corrected in the direction of the greatest increase in signal strength. Therefore, the transmitting diode 12 and the receiver 13 can be aligned optimally to a signal maximum.

It is conceivable that such a gradient method is also performed continuously during an established connection to another transmitter 2, in order to update the transmitter 1 corresponding to the signal maximum, for example, after a change in position in the room, so that the best possible connection quality is guaranteed at each time. In the case of the automated alignment of the transmitter 1, a display 7 is no longer needed directly, but can be optionally provided to the user for inspection.

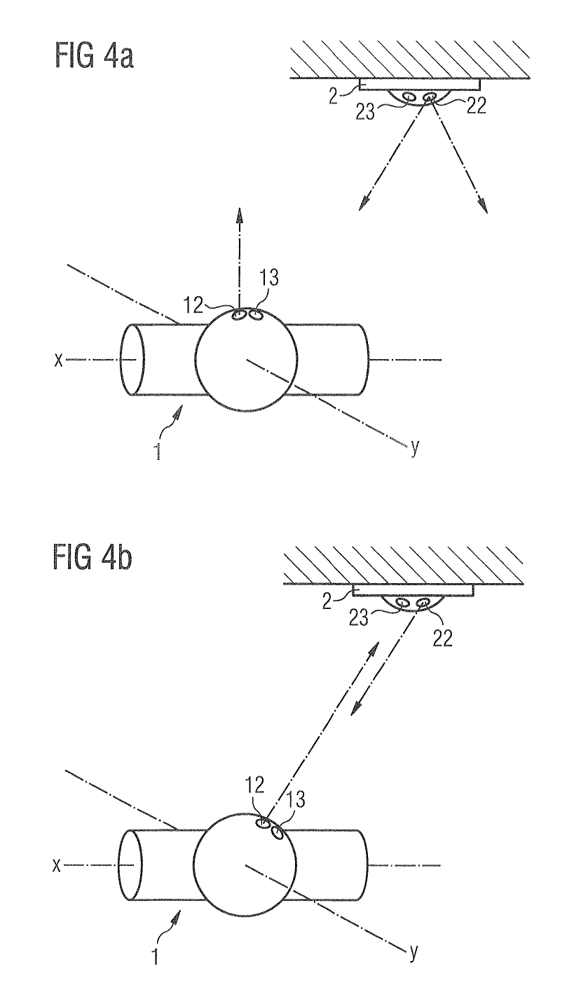

FIG. 4a shows one arrangement of a transmitter 1 with another transmitter 2 in a first operating state of the transmitter 1. The additional transmitter 2 is integrated, for example, in the ceiling lighting of a room and sends continuous visible light from a transmitting diode 22 at a certain emission angle that is shown by two dashed arrows into the room. The transmitter 1 is supported so that it can pivot with its transmitting diode 12 and its receiver 13 about two rotational axes X and Y. In the operating state according to FIG. 4a, the transmitting diode 12 and the receiver 13 of the transmitter 1 are aligned perpendicularly, wherein emitted light pulses of the transmitting diode 12 are emitted into the room and can be detected only inadequately by the receiver 23 of the other transmitter 2. In this operating state, a data connection is possible with only a very poor signal quality or, in some circumstances, not at all. This means that the transmitter 1 must be aligned to the other transmitter 2 for improved signal quality.

FIG. 4b shows a second operating state of the transmitter 1 after an automated alignment of the transmitting diode 12 and the receiver 13 to the other transmitter 2. In this way, the transmitting diode 12 and the receiver 13 were pivoted relative to the rotational axes X and Y, such that they have direct visual contact with the transmitting diode 22 and the receiver 23 of the other transmitter 2. Automated alignment could be performed here by means of one or more electrical drives that pivot the transmitter 1 about the rotational axes X and Y. A maximum search takes place here according to the processing steps named above. In FIG. 4b, a transmitting diode 12 of the transmitter 1 can send out visible light to a receiver 23; in contrast, the receiver 13 detects light signals that were emitted by the transmitting diode 22. The automated alignment of the transmitter 1 to the other transmitter 2 guarantees a simple and quick detection of the best possible signal strength for establishing an optical data connection between the two transmitters 1 and 2. Here, it is also conceivable that the transmitting diode 12 and the receiver 13 are continuously moved in the room along with the signal maximum by means of a gradient method in the case of a changed position of the transmitter 1 in the room. It is similarly conceivable that the transmitter 1 is aligned not with the primary lobe, that is, direct visual contact with the second transmitter 2, but instead with a secondary lobe produced by reflections in the room.

In additional embodiments that are not shown, a transmitter 1, similar to a webcam, could be integrated in the monitor of a portable or desktop computer system. An alignment to another transmitter 2 in the room could be performed manually or automatically, wherein the transmitter could be pivoted about arbitrary rotational axes in the room. The rotational axes need not necessarily be arranged orthogonal to each other.

The alignment and emission characteristics of the two transmitters 1 and 2 can have directional or diffuse configurations. In the directional case, however, reduced energy consumption is required for transmitting and receiving data within the optical data network. The disclosed invention allows a transmitter to be aligned in a room quickly, easily, and in an energy-efficient way, so that an optimum data connection to another transmitter in the room is guaranteed. For this purpose, the exact position of the other transmitter need not be known.

For the automatic alignment of a transmitter 1 in the direction of a detected signal maximum, any method for finding the maximum, such as, for example, the gradient method, Newton's method, as well as other static or dynamic optimization methods, could be used.

What is claimed is:

1. A device for use in an optical data network, the device comprising:
a receiver for receiving data transmitted wirelessly by means of modulated light from a transmitter, wherein, during operation, the receiver is aligned to the transmitter as a function of a signal strength measured by the receiver; and
a data port for connecting to a computer system.

2. The device according to claim 1, further comprising a transmitting diode for generating modulated light to be sent as data.

3. The device according to claim 2, wherein the receiver and the transmitting diode are automatically aligned to an other transmitter.

4. The device according to claim 1, wherein the receiver is automatically aligned to an other transmitter.

5. The device according to claim 1, wherein the device provides the measured signal strength on the data port.

6. The device according to claim 1, further comprising a display for displaying the signal strength measured by the receiver.

7. The device according to claim 1, wherein the receiver is supported so that it can pivot about a first rotational axis and about a second rotational axis that is perpendicular to the first rotational axis.

8. The device according to claim 1, further comprising a flexible gooseneck having a first end coupled to the data port and a second end coupled to the receiver.

9. The device according to claim 1, wherein the receiver comprises a photodiode or a phototransistor.

10. The device according to claim 1, wherein the modulated light comprises modulated visible light.

11. A method for transmitting data in an optical data network, the method comprising:
automatically aligning a receiver to a transmitter if a connection to the transmitter is to be established or maintained; and
receiving data from the transmitter, the data being transmitted wirelessly from the transmitter by means of modulated visible light.

12. The method according to claim 11, further comprising automatically aligning the transmitter.

13. The method according to claim 11, further comprising measuring a signal strength at the receiver.

14. The method according to claim 13, wherein measuring the signal strength comprises measuring the signal strength in a plurality of spatial directions and wherein automatically aligning comprises aligning to an angular position in which the greatest signal strength was measured.

15. The method according to claim 13, further comprising detecting a change in signal strength in a first rotational direction and in a second rotational direction perpendicular to the first rotational direction, wherein automatically aligning comprises varying a receiver position as a function of a direction of the largest increase in signal strength.

16. The method according to claim 13, wherein automatically aligning comprises panning about a first rotational axis and then taking up an angular position relative to the first rotational axis in which the greatest signal strength was measured.

17. The method according to claim 16, wherein automatically aligning further comprises panning about a second rotational axis perpendicular to the first rotational axis and then taking up an angular position relative to the second rotational axis in which the greatest signal strength was measured.

18. The method according to claim 11, wherein the automatically aligning is performed before receiving the data, the method further comprising measuring a signal strength of the received data in a plurality of spatial directions and automatically realigning to an angular position in which the greatest signal strength was measured.

19. The method according to claim 18, wherein measuring the signal strength and realigning are performed after a specified time period has elapsed.

20. The method according to claim 13, further comprising outputting a warning signal if the greatest measured signal strength falls below a specified limiting value.

21. The method according to claim 13, further comprising automatically realigning the receiver to the transmitter if the greatest measured signal strength falls below a specified limiting value.
